(19) United States
(12) Patent Application Publication
(10) Pub. No.: US 2012/0102394 A1
(43) Pub. Date: Apr. 26, 2012

(54) APPLICATION OF PATH-FILL ALGORITHM TO TEXT LAYOUT AROUND OBJECTS

(75) Inventor: Kurt N. Nordback, Boulder, CO (US)

(73) Assignee: KONICA MINOLTA SYSTEMS LABORATORY INC., San Mateo, CA (US)

(21) Appl. No.: 12/911,256

(22) Filed: Oct. 25, 2010

(51) Int. Cl. G06F 17/00

(52) U.S. Cl. 715/247

(57) ABSTRACT

A method including: obtaining an electronic document (ED) including a text line for placement on a page having an exclusion region (ER); obtaining a path for the page having a first subpath corresponding to a margin of the page and a second subpath corresponding to the ER on the page; calculating, using a path-fill algorithm inputting the path, a region on the page excluding the margin and the ER; selecting, on the page and after calculating the region, a line band crossing the ER on the page and having a dimension of the text line; identifying, based on an intersection of the region and the line band, a plurality of segments; and rendering the page by placing a first portion of the text line in a first segment of the plurality of segments and a second portion of the text line in a second segment of the plurality of segments.

### BACKGROUND

Filling (with a color, for example) within a path on a 2-dimensional plane is a common problem in computer graphics, and algorithms for how to do it (i.e., path-fill algorithms) are common and well established. These algorithms typically produce, as their result, scanlines of pixels that are to be colored.

In modern software applications, such as word processors and page-layout applications, it is possible to create pages with text tightly placed around another object such as an image or graphic. The text may wrap around all sides of the object. In such situations, it is necessary to maintain the integrity of words. Given that many such objects can be on a page, and that their shapes can be arbitrary, algorithms to determine how to lay out the text can be quite complex, and unlike path-fill algorithms, are uncommon and not established. This, in turn, means that the computer code and hardware to implement such an algorithm can be time-consuming and error-prone to write and to maintain.

### SUMMARY

In general, in one aspect, the invention relates to a method for placing text lines on a page. The method comprises: obtaining an electronic document (ED) comprising a text line for placement on a page having an exclusion region (ER); obtaining a path for the page comprising a first subpath corresponding to a margin of the page and a second subpath corresponding to the ER on the page; calculating, using a path-fill algorithm inputting the path, a region on the page excluding the margin and the ER; selecting, on the page and after calculating the region, a line band crossing the ER on the page and comprising a dimension of the text line; identifying, based on an intersection of the region and the line band, a plurality of segments; and rendering the page by placing a first portion of the text line in a first segment of the plurality of segments and a second portion of the text line in a second segment of the plurality of segments.

In general, in one aspect, the invention relates to a non-transitory computer readable storage medium storing instructions for placing text lines on a page. The instructions comprise functionality to: obtain an electronic document (ED) comprising a text line for placement on a page having an exclusion region (ER); obtain a path for the page comprising a first subpath corresponding to a margin of the page and a second subpath corresponding to the ER on the page; calculate, using a path-fill algorithm inputting the path, a region on the page excluding the margin and the ER; select, on the page and after calculating the region, a line band crossing the ER on the page and comprising a dimension of the text line; identify, based on an intersection of the region and the line band, a plurality of segments; and render the page by placing a first portion of the text line in a first segment of the plurality of segments and a second portion of the text line in a second segment of the plurality of segments.

In general, in one aspect, the invention relates to a system for placing text lines on pages. The system comprises: a hardware processor; a path generation module executing on the hardware processor and configured to define a path on a page of an electronic document comprising a text line and an exclusion region (ER), wherein the path comprises a first subpath corresponding to a margin of the page and a second subpath corresponding to the ER; a path-fill module executing on the hardware processor and configured to calculate a region on the page based on the path; and a placement module executing on the processor and configured to: select a line band crossing the ER on the page and comprising a dimension of the text line; identify, based on an intersection of the region and the line band, a plurality of segments; and render the page by placing a first portion of the text line in a first segment of the plurality of segments and a second portion of the text line in a second segment of the plurality of segments.

Other aspects of the invention will be apparent from the following description and the appended claims.

### BRIEF DESCRIPTION OF DRAWINGS

FIG. 1 shows a block diagram depicting a system in accordance with one or more embodiments of the invention.

FIG. 2 shows a page in accordance with one or more embodiments of the invention.

FIG. 3 shows a flowchart in accordance with one or more embodiments of the invention.

FIG. 4 shows an example in accordance with one or more embodiments of the invention.

FIG. 5 shows a computer system in accordance with one or more embodiments of the invention.

### DETAILED DESCRIPTION

Specific embodiments of the invention will now be described in detail with reference to the accompanying figures. Like elements in the various figures are denoted by like reference numerals for consistency.

In the following detailed description of embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description.

In general, embodiments of the invention provide a system and method for using path-fill algorithms to place text around exclusion regions (e.g., clipart, photographs, video clips, etc.) of any shape on a page. Specifically, for each page, a vector path is obtained having a margin subpath corresponding to the margins of the page and one or more exclusion region subpaths corresponding to the exclusion regions on the page. A region on the page for placing text is calculated using a path-fill algorithm whose input is the vector path. Further, for each text line, a line band is created and positioned on the page. The line band has the same height as the text line, and is located at the same vertical position as the text line, and extends the full width of the page. The text of the text line may be placed in segments resulting from the intersection of the line band and the region.

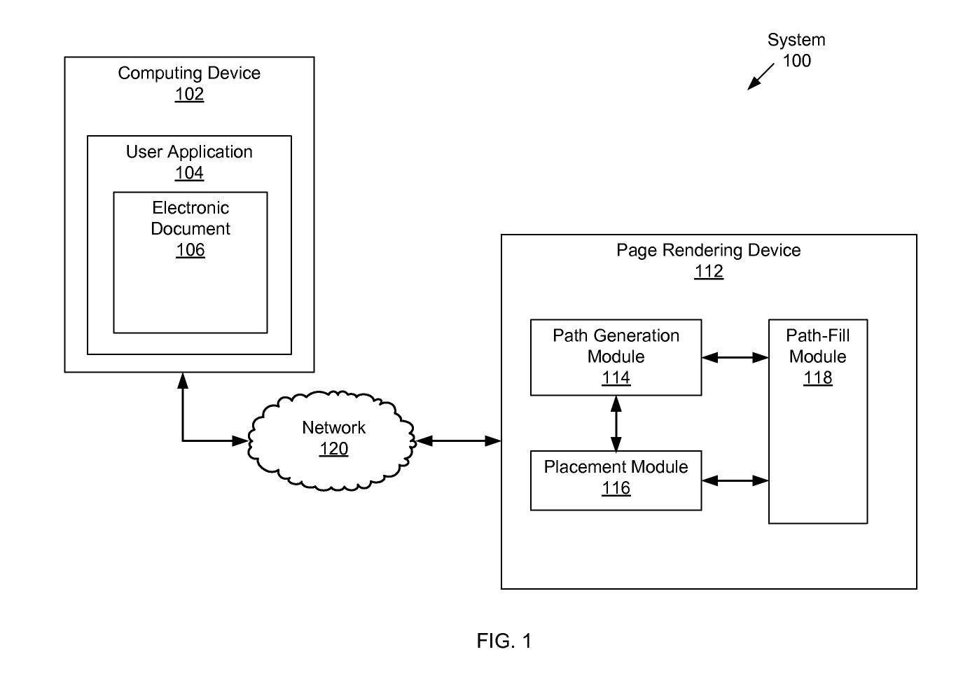

FIG. 1 shows a system (100) in accordance with one or more embodiments of the invention. As shown in FIG. 1, the system (100) has multiple components including a page rendering device (112) and a computing device (102). The PRD (112) may be a printer, an electronic reader, etc. The computing device (102) may be a personal computer (PC), a desktop computer, a mainframe, a server, a telephone, a kiosk, a cable box, a personal digital assistant (PDA), an electronic reader, a mobile phone, a smart phone, etc. There may be a direct connection (e.g., universal serial bus (USB) connection) between the computing device (102) and the PRD (112). Alternatively, the computing device (102) and the PRD (112) may be connected using a network (120) having wired and/or wireless segments.

In one or more embodiments of the invention, the PRD (112) is located on the computing device (102). In such embodiments, the PRD (112) may correspond to any combination of hardware and software on the computing device (102) for rendering the ED.

In one or more embodiments of the invention, the computing device (102) executes the user application (104). The user application (104) is a software application operated by a user and configured to obtain, input, generate, display, and/or print an ED (e.g., Electronic Document (106)) having any number of pages. Accordingly, the user application (104) may be a word-processing application, a spreadsheet application, a desktop publishing application, a graphics application, a photograph printing application, an Internet browser, etc. The user application (104) may generate new EDs and/or obtain previously saved EDs.

In one or more embodiments of the invention, each page of the ED (106) includes one or more text lines (e.g., a title, a subheading, a paragraph, a single sentence, a single word, a signature block, etc.) and/or zero or more exclusion regions (e.g., clipart, a photograph, a scanned image, a video clip, an audio clip, etc.). In general, the term “exclusion region” applies to an area of the page where text cannot be placed because the area is occupied by clipart, a photograph, a video clip, etc. Accordingly, the ED (106) may specify the margins of a page, the positions (i.e., coordinates) of the text lines on the page (explicitly or, more commonly, implicitly), the dimensions (e.g., height and/or widths) of the text lines, the font type, font style, font size of the text in the text lines, etc. Similarly, the ED (106) may specify the positions (i.e., coordinates) of the exclusion regions, the dimensions of the exclusion regions (i.e., height, width), etc. The ED (106) may specify the positions of the exclusion regions relative to the page, relative to some marker in the text, relative to a text structure such as a paragraph or (for horizontal positioning) a column, or in other fashions which depend on the particular layout of the text.

In one or more embodiments of the invention, the ED (106) is represented/defined using a document markup language (e.g., ODF, OOXML, HTML, etc.). Accordingly, the properties/attributes of the pages, the text lines, and the exclusion regions (i.e., positions, dimensions, font sizes, font styles, margins, etc.) in the ED (106) may be recorded as attributes within the tags of the document markup language. Moreover, these properties/attributes are needed to correctly render the ED (106) for display or printing.

In one or more embodiments of the invention, the PRD (112) includes a path generation module (114). The path generation module (114) is configured to define a path (i.e., vector path) on a page of the ED (106). The path will generally include an outer closed subpath corresponding to the margins of the page (i.e., margin subpath), plus one or more closed subpaths corresponding to the exclusion regions of the page (i.e., exclusion region subpaths). In one or more embodiments of the invention, the margin subpath and the one or more exclusion region subpaths are rectangular in shape. Alternatively, the margin subpath and the one or more exclusion region subpaths may be any shape. The multiple exclusion regions need not be disjoint and need not be contained by the margin subpath. In one or more embodiments of the invention, the margin subpath and the exclusion region subpath(s) are assigned opposite directions. For example, the margin subpath may be assigned the counterclockwise direction, while the one or more exclusion region subpaths may be assigned the clockwise direction.

In one or more embodiments of the invention, the PRD (112) includes a path-fill module (118). The path-fill module (118) is configured to input a vector path and a fill rule and output a region on the page where text can be placed. In one or more embodiments of the invention, the fill rule corresponds to the set of points on the page having a counterclockwise winding number of +1. Accordingly, the path-fill module (118) may include a path-fill algorithm that calculates the region based on the vector path and the fill rule. Those skilled in the art, having the benefit of this detailed description, will appreciate that the fill rule and/or directions assigned to the subpaths may need to be modified/converted depending on the path-fill algorithm being used.

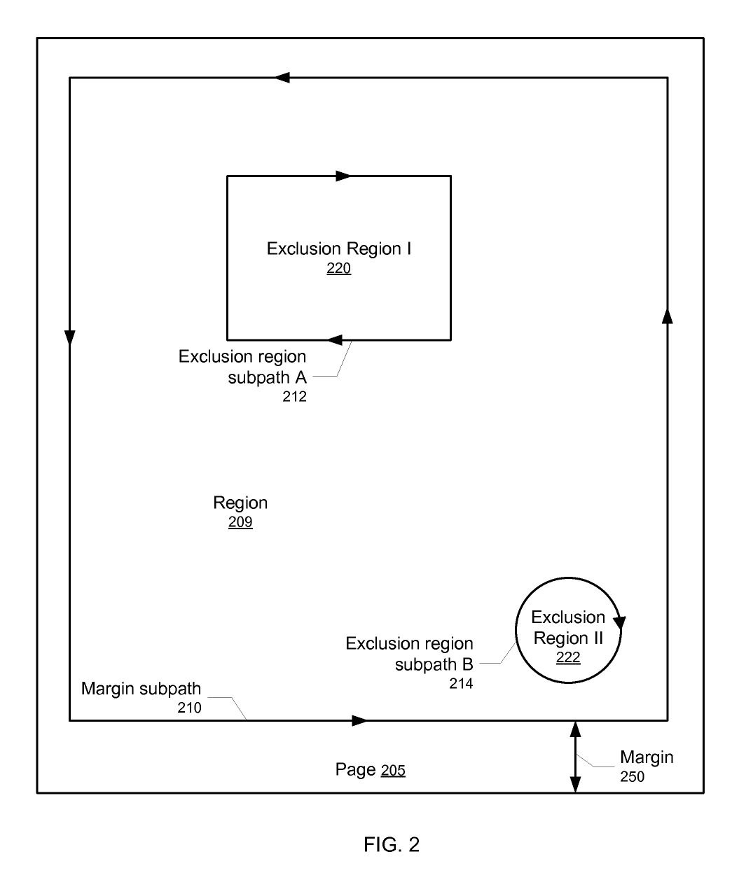

FIG. 2 shows a page (205) in accordance with one or more embodiments of the invention. As shown in FIG. 2, the page (205) includes a margin subpath (210) corresponding to the margin (250) of the page (205). The page (205) also includes multiple exclusion region subpaths (i.e., Exclusion Region Subpath A (212), Exclusion Region Subpath B (214), etc.) corresponding to multiple exclusion regions (i.e., Exclusion Region I (220), Exclusion Region II (222)) on the page (205). The vector path for the page (205) includes the margin subpath (210) and the multiple exclusion region subpaths (212, 214). As discussed above, each exclusion region (220, 222) corresponds to an area of the page of any shape where text cannot be placed because the area is occupied by clipart, a photograph, a video clip, etc. As also discussed above, the margin subpath (210) and the exclusion region subpaths (212, 214) are assigned different directions (i.e., counterclockwise, clockwise, etc.).

In one or more embodiments of the invention, the region (209) is calculated by the path-fill module (118) and corresponds to the portion of the page (205) where text lines can be placed. Specifically, the region (209) corresponds to the points on the page (205) having a winding number of +1 with respect to the path.

Referring back to FIG. 1, in one or more embodiments of the invention, the PRD (112) includes a placement module (116). The placement module (116) is configured to identify a text line in the ED (106); identify and/or calculate the dimensions (i.e., height and/or width) of the text line from the properties/attributes specified in the ED (106); select and position a line band on the page based on the text line (discussed below); identify multiple segments on the page using the line band (discussed below); and place the text of the text line within the multiple segments (discussed below).

In one or more embodiments of the invention, in the case of Western languages, the line band corresponds to a horizontal strip having the same height as the text line and placed at a vertical location on the page corresponding to the vertical position of the text line. Accordingly, the vertical position may be below the top margin, or below the previous text line placed on the page, or at any location specified or calculated from the ED (106).

Alternatively, in the case of vertical text layout (e.g., for certain Eastern languages), the line band may correspond to a vertical strip having the same width as the text line and placed at a horizontal location on the page corresponding to the horizontal position of the text line. Accordingly, the horizontal position may be adjacent to the margin, or adjacent to the previous text line placed on the page, or at any location specified or calculated from the ED (106).

In one or more embodiments of the invention, the one or more segments identified by the placement module (116) correspond to the intersection of the line band and the region calculated by the path-fill module (118). In one or more embodiments of the invention, placing the text of the text line within the multiple segments requires partitioning the text line according to language rules (e.g., line breaking, hyphenation rules, etc.).

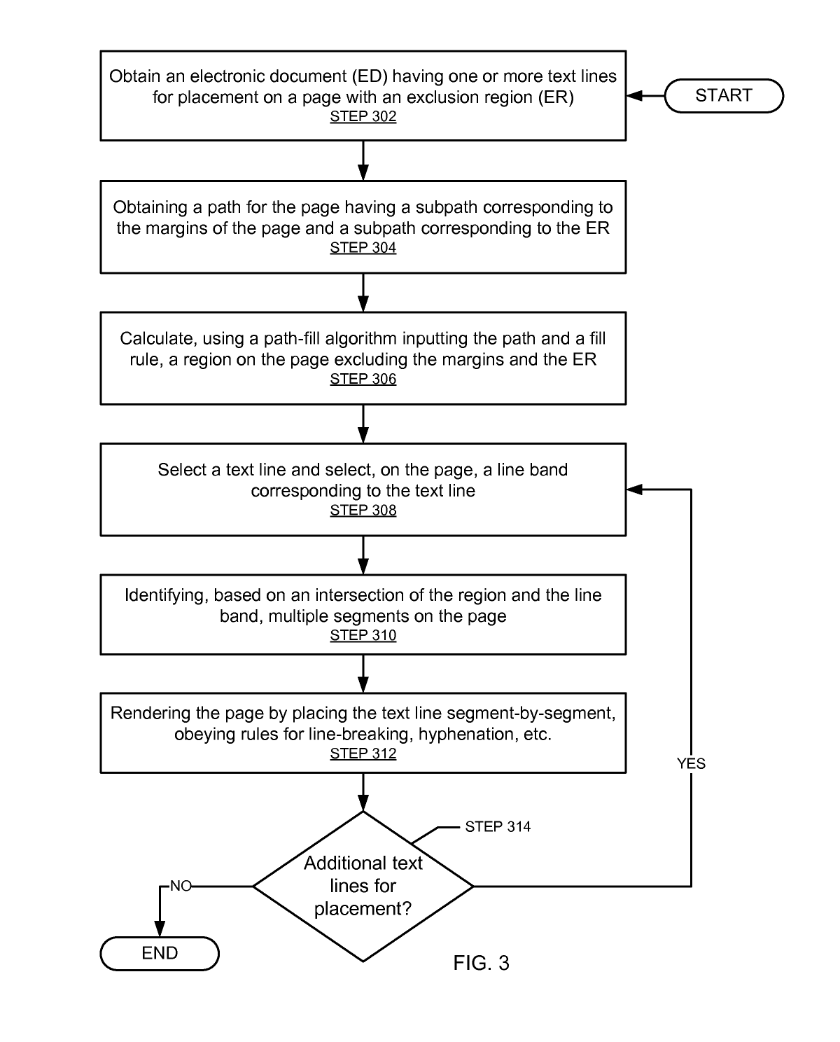

FIG. 3 shows a flowchart describing a process in accordance with one or more embodiments of the invention. The process depicted in FIG. 3 may be implemented using the system (100), described above in reference to FIG. 1. One or more steps shown in FIG. 3 may be omitted, repeated, and/or performed in a different order among different embodiments of the invention. Accordingly, embodiments of the invention should not be considered limited to the specific number and arrangement of steps shown in FIG. 3.

Initially, an ED is obtained (STEP 302). The ED has one or more text lines for placement on a page of the ED. Further, the page may include one or more exclusion regions corresponding to areas on the page where text cannot be placed. The exclusion regions may be occupied by clipart, photographs, video clips, or other types of media.

As discussed above, the ED (106) may be represented/defined using a document markup language (e.g., ODF, OOXML, etc.). Accordingly, the properties (i.e., attributes) of the pages, the text lines, and the exclusion regions (i.e., positions, dimensions, font sizes, font styles, margins, etc.) in the ED (106) may be recorded as attributes within the tags of the document markup language.

In STEP 304, a vector path for the page is obtained. The vector path includes a margin subpath corresponding to the margins of the page. The vector path also includes one or more exclusion region subpaths corresponding to the one or more exclusion regions on the page. As discussed above, the multiple exclusion regions need not be disjoint and need not be contained by the margin subpath. Further, in one or more embodiments of the invention, the margin subpath and the exclusion region subpath(s) are assigned opposite directions. For example, the margin subpath may be assigned the counterclockwise direction, while the one or more exclusion region subpaths may be assigned the clockwise direction.

In STEP 306, the region on the page excluding the margins and the exclusion region(s) is calculated based on the vector path. Specifically, the region is the output of a fill-path algorithm that inputs the vector path and a fill rule. In the embodiments of the invention where the margin subpath is assigned the counterclockwise direction and the one or more exclusion regions are assigned the clockwise direction, the fill rule corresponds to the set of points on the page having a winding number of +1.

In STEP 308, a text line of the ED is selected. In addition, a line band corresponding to the selected text line is placed on the page. In one or more embodiments of the invention, the line band has a dimension (e.g., height and/or width) matching a corresponding dimension of the text line. For example, in the case of a horizontal line band, the height of the horizontal line band corresponds to the height of the text line. In the case of a vertical line band, the width of the vertical line band corresponds to the width of the text line. Further, the position of the horizontal/vertical line band on the page corresponds to the vertical/horizontal position of the text line on the page. For example, the position may be below/adjacent to a margin of the page, or below/adjacent to a previously placed text line, or at any position specified by the ED.

In STEP 310, one or more segments on the page are identified. Specifically, the one or more segments are identified by performing an intersect operation between the region and the line band (i.e., segment(s)=region ∩ line band). Those skilled in the art, having the benefit of this detailed description, will appreciate that when the line band crosses one or more exclusion regions, it is likely that the intersection operation will produce multiple segments (i.e., segments on both sides of the exclusion region(s)). Similarly, when the line band does not cross any exclusion regions, it is likely that the intersection operation will produce only one segment spanning the page inside the margins.

In STEP 312, the portion of the page corresponding to the line band is rendered by placing the text of the text line segment-by-segment. Accordingly, it may be necessary to partition the text (i.e., a first portion of the text for a first segment, a second portion of the text for a second segment, etc.) according to rules for line-breaking, hyphenation, etc. The rules are dependent on, and thus will vary with, the language of the text in the text line and parameters specified in the ED.

In STEP 314, it is determined whether the ED has additional text lines for placement on the page. When it is determined that the ED has additional text lines for placement on the page, the process returns to STEP 308. When it is determined that all of the text lines have been placed, the process ends.

Although FIG. 3 includes the calculation of the entire region in a single step (i.e., STEP 306), those skilled in the art, having the benefit of this detailed description, will appreciate that in other embodiments of the invention, the region may be calculated in multiple steps. Specifically, for a given text line, only the segment of the region within the perimeter of the line band corresponding to the text line is calculated. The intersection operation is then performed with the recently calculated segment and the line band.

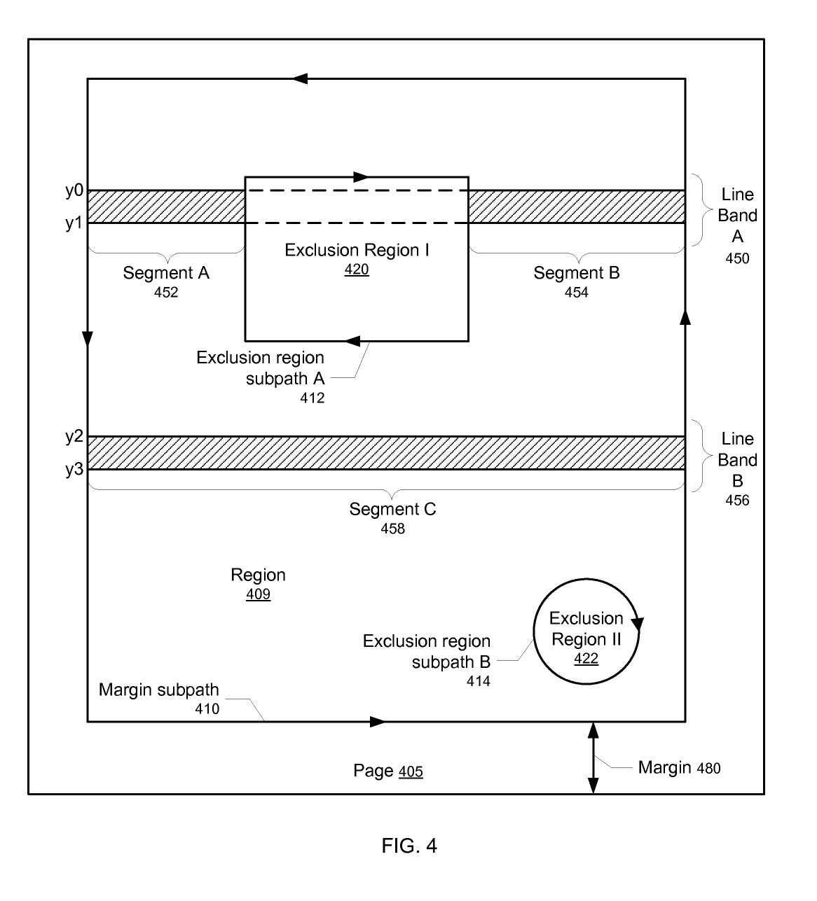

FIG. 4 shows an example in accordance with one or more embodiments of the invention. Specifically, FIG. 4 shows a page (405) of an ED (not shown). The page (405) has margins (480) and multiple exclusion regions (i.e., Exclusion Region I (420), Exclusion Region II (422)). As discussed above, the exclusion regions correspond to areas of the page (405) occupied by clipart, photographs, video clips, or other types of media and are generally areas on the page where text cannot be placed. The region (409) of the page (405) is calculated by a path-fill algorithm that inputs a vector path comprising the margin subpath (410) and the multiple exclusion region subpaths (i.e., Exclusion region subpath A (412), Exclusion region subpath B (414)). As discussed above, the region (409) corresponds to an area on the page (405) where text may be placed.

Still referring to the example of FIG. 4, the ED (not shown) includes multiple text lines. The heights and positions (i.e., coordinates) of the text lines may either be explicitly specified in the ED, or calculated from values in the ED. The line band A (450) corresponds to a text line (“text line A”) in the ED. Specifically, the line band A (450) has a vertical position (i.e., y0, y1) corresponding to the vertical position of the text line A. The line band A (450) also has a height (i.e., |y1−y0|) corresponding to the height of the text line A. As shown in FIG. 4, the line band A (450) crosses the exclusion region I (420). As also shown in FIG. 4, the intersection of the line band A (450) and the region (409) results in segment A (452) and segment B (454), which are on opposite sides of the exclusion region I (420). Accordingly, a first portion of text line A may be placed in the segment A (452) and a second portion of the text line A may be placed in the segment B (454). The splitting point of the text line A into the first portion and the second portion is based on the widths of the segment A (452) and the segment B (454) and the line-break and hyphenation rules of the language of the text line.

The line band B (456) corresponds to a text line (“text line B”) in the ED. Specifically, the line band B (456) has a vertical position (i.e., y2, y3) corresponding to the vertical position of the text line B. The line band B (456) also has a height (i.e., |y3−y2|) corresponding to the height of the text line B. As shown in FIG. 4, the line band B (456) does not cross any exclusion regions (420,422). Accordingly, the intersection of the line band B (456) and the region (409) results in segment C (458), which spans the entire page within the margins (480). Accordingly, the text of text line B is placed in the segment C (458).

Embodiments of the invention have one or more of the following advantages: the ability to solve a text-layout problem by viewing it as a path-fill problem; the ability to lay out text tightly around another object such as an image or graphic using a known path-fill algorithm; the ability to avoid use of error-prone custom algorithms in determining how to lay out text around objects having arbitrary shapes, etc.

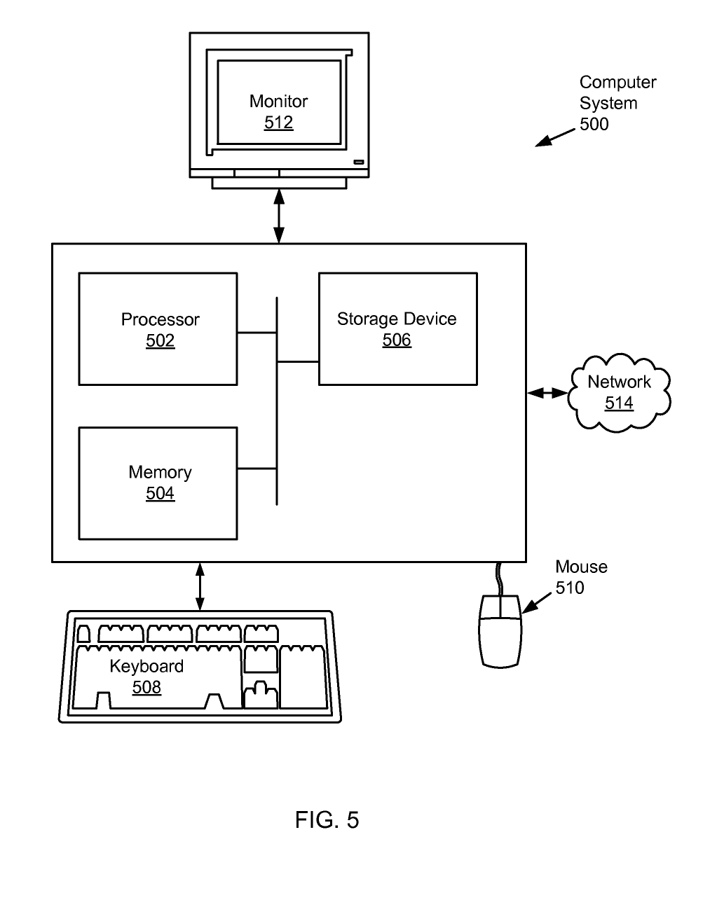

Embodiments of the invention may be implemented on virtually any type of computer regardless of the platform being used. For example, as shown in FIG. 5, computer system (500) includes one or more processor(s) (502), associated memory (504) (e.g. random access memory (RAM), cache memory, flash memory, etc.), storage device (506) (e.g. a hard disk, an optical drive such as a compact disk drive or digital video disk (DVD) drive, a flash memory stick, etc.), and numerous other elements and functionalities typical of today's computers (not shown). In one or more embodiments of the invention, processor (502) is hardware. For example, the processor may be an integrated circuit. Computer system (500) may also include input means, such as keyboard (508), mouse (510), or a microphone (not shown). Further, computer system (500) may include output means, such as monitor (512) (e.g. a liquid crystal display (LCD), a plasma display, or cathode ray tube (CRT) monitor). Computer system (500) may be connected to network (514) (e.g. a local area network (LAN), a wide area network (WAN) such as the Internet, or any other type of network) via a network interface connection (not shown). In one or more embodiments of the invention, many different types of computer systems exist, and the aforementioned input and output means may take other forms. Generally speaking, computer system (500) includes at least the minimal processing, input, and/or output means necessary to practice embodiments of the invention.

Further, in one or more embodiments of the invention, one or more elements of the aforementioned computer system (500) may be located at a remote location and connected to the other elements over a network. Further, embodiments of the invention may be implemented on a distributed system having a plurality of nodes, where each portion of the invention (e.g. data structure, converter module, layout engine) may be located on a different node within the distributed system. In one embodiment of the invention, the node corresponds to a computer system. Alternatively, the node may correspond to a processor with associated physical memory. The node may alternatively correspond to a processor or micro-core of a processor with shared memory and/or resources. Further, software instructions in the form of computer readable program code to perform embodiments of the invention may be stored, temporarily or permanently, on a non-transitory computer readable storage medium, such as a compact disc (CD), a diskette, punch cards, a tape, memory, or any other computer readable storage device.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A method for placing text lines on a page, comprising:
obtaining an electronic document (ED) comprising a text line for placement on a page having an exclusion region (ER);
obtaining a path for the page comprising a first subpath corresponding to a margin of the page and a second subpath corresponding to the ER on the page;
calculating, using a path-fill algorithm inputting the path, a region on the page excluding the margin and the ER;
selecting, on the page and after calculating the region, a line band crossing the ER on the page and comprising a dimension of the text line;
identifying, based on an intersection of the region and the line band, a plurality of segments; and
rendering the page by placing a first portion of the text line in a first segment of the plurality of segments and a second portion of the text line in a second segment of the plurality of segments.

2. The method of claim 1, wherein the line band is a horizontal line band, wherein the dimension is a height of the text line, and wherein the plurality of segments are horizontal segments.

3. The method of claim 1, wherein the first subpath has a counterclockwise direction, wherein the second subpath has a clockwise direction, and wherein the path-fill algorithm inputs a fill rule corresponding to a winding number of positive one.

4. The method of claim 1, wherein the ER is a digital photograph.

5. The method of claim 1, wherein the ER is clipart.

6. The method of claim 1, further comprising:
identifying the first portion of the text line and the second portion of the text line based on a hyphenation rule of a language of the text line.

7. The method of claim 1, wherein the first segment and the second segment are on opposite sides of the ER.

8. A non-transitory computer readable storage medium storing instructions for placing text lines on a page, the instructions comprising functionality to:
obtain an electronic document (ED) comprising a text line for placement on a page having an exclusion region (ER);
obtain a path for the page comprising a first subpath corresponding to a margin of the page and a second subpath corresponding to the ER on the page;
calculate, using a path-fill algorithm inputting the path, a region on the page excluding the margin and the ER;
select, on the page and after calculating the region, a line band crossing the ER on the page and comprising a dimension of the text line;
identify, based on an intersection of the region and the line band, a plurality of segments; and
render the page by placing a first portion of the text line in a first segment of the plurality of segments and a second portion of the text line in a second segment of the plurality of segments.

9. The non-transitory computer readable storage medium of claim 8, wherein the line band is a horizontal line band, wherein the dimension is a height of the text line, and wherein the plurality of segments are horizontal segments.

10. The non-transitory computer readable storage medium of claim 8, wherein the first subpath has a counterclockwise direction, wherein the second subpath has a clockwise direction, and wherein the path-fill algorithm inputs a fill rule corresponding to a winding number of positive one.

11. The non-transitory computer readable storage medium of claim 8, wherein the ER is a digital photograph.

12. The non-transitory computer readable storage medium of claim 8, wherein the ER is a clipart image.

13. The non-transitory computer readable storage medium of claim 8, the instructions further comprising functionality to:
identify the first portion of the text line and the second portion of the text line based on a hyphenation rule of a language of the text line.

14. The non-transitory computer readable storage medium of claim 8, wherein the first segment and the second segment are on opposite sides of the ER.

15. A system for placing text lines on pages, comprising:
a hardware processor;
a path generation module executing on the hardware processor and configured to define a path on a page of an electronic document comprising a text line and an exclusion region (ER),
wherein the path comprises a first subpath corresponding to a margin of the page and a second subpath corresponding to the ER;
a path-fill module executing on the hardware processor and configured to calculate a region on the page based on the path; and
a placement module executing on the processor and configured to:
select a line band crossing the ER on the page and comprising a dimension of the text line;
identify, based on an intersection of the region and the line band, a plurality of segments; and
render the page by placing a first portion of the text line in a first segment of the plurality of segments and a second portion of the text line in a second segment of the plurality of segments.

16. The system of claim 15, wherein the path generation module, the path-fill module, and the placement module are located on a printer.

17. The system of claim 15, wherein the line band is a horizontal line band, wherein the dimension is a height of the text line, and wherein the plurality of segments are horizontal segments.

18. The system of claim 15, wherein the first subpath has a counterclockwise direction, wherein the second subpath has a clockwise direction, and wherein the path-fill algorithm inputs a fill rule corresponding to a winding number of positive one.

19. The system of claim 15, wherein the ER is a digital photograph.

20. The system of claim 15, wherein the placement module is further configured to:
identify the first portion of the text line and the second portion of the text line based on a hyphenation rule of a language of the text line.
